(19) United States
(12) Patent Application Publication
(10) Pub. No.: US 2010/0179270 A1
(43) Pub. Date: Jul. 15, 2010

(54) LAMP BLACK

(76) Inventors: Heinz Zoch, Maintal (Dornigheim) (DE); Alfons Karl, Grundau (DE); Johann Mathias, Kahl (DE); Jutta Zimmermann, Alzenau (DE); Joachim Fröhlich, Bornheim (DE); Manfred Dannehl, Kahl (DE); Frank Stenger, Alzenau (DE)

Correspondence Address: SMITH, GAMBRELL & RUSSELL, 1130 CONNECTICUT AVENUE, N.W., SUITE 1130, WASHINGTON, DC, 20036, US

(21) Appl. No.: 12/602,755

(22) PCT Filed: May 20, 2008
(86) PCT No.: PCT/EP08/56206

§ 371 Date: Dec. 2, 2009

(30) Foreign Application Priority Data
Jun. 5, 2007 (DE) 102007026214.2

(51) Int. Cl. C08K 3/04; C01B 31/00

(52) U.S. Cl. 524/495; 423/449.1

(57) ABSTRACT

The invention relates to lamp blacks having a DBP value of less than 100 ml/100 g. The invention also relates to a method for producing said lamp black, wherein lamp black is mechanically size-reduced in a rotary ball mill. The lamp blacks according to the invention can be used in carbon black dispersions, paint systems, printing inks, plastic mixtures and rubber mixtures.

The present invention relates to lamp black, to a process for its production, and to its use.

The apparatus used for lamp black is known to consist of a cast-iron pan to which the liquid or, if appropriate, molten raw material is charged, and a fire-resistant extraction hood lined with refractory material. The raw material, generally an oil with high aromatic content, is continuously introduced in order to maintain a constant level of raw material in the pan. The air gap between pan and extraction hood, and also the level of reduced pressure in the system, serve for regulation of air feed and thus for adjustment of properties. The heat radiated from the extraction hood causes vaporization, and some combustion, of the raw material, but this material is mainly converted into industrial carbon black. In order to isolate the solid, the process gases comprising carbon black are cooled and then passed through a filter, the carbon black being isolated from the exhaust gas. (Prof. Donnet, Carbon Black, MARCEL DEKKER Verlag, 1993, second edition, pages 54-57).

JP 63201009 A discloses the treatment of carbon black powders, for example channel blacks or furnace blacks, with a ball mill. Ball mills achieve a specific energy input of from 0.01 to 0.03 kW/l. The ball mill transfers the energy mainly by way of shear and friction (http://www.zoz.de/pdf_dateien/publications/v31.pdf, manuscript by H. Zoz, Simoloyer®: major characteristics and features).

DE 43 36 548 moreover discloses a process for the production of spherical pellets in an annular die press.

EP 0 808 880 discloses a process for the production of silanized silica which has little thickening effect, where the hydrophobic silanized silica is destructured/compacted by mechanical action.

Disadvantages of the known lamp blacks are the very high levels of structure resulting from the production process; these lead to high viscosities in solvent-containing and aqueous systems, and permit only low filler levels in systems using lamp black.

It is an object of the present invention to provide a lamp black with a reduced level of structure.

The invention provides a lamp black characterized in that its DBP value is smaller than 100 ml/100 g, preferably smaller than 90 ml/100 g, particularly preferably smaller than 80 ml/100 g, measured to ASTM D 2414-00.

The CDBP of the lamp black of the invention, measured to ASTM D 3493-00, can be smaller than 62 ml/100 g, preferably smaller than 58 ml/100 g, particularly preferably smaller than 55 ml/100 g.

The difference between DBP and CDBP of the lamp black of the invention can be smaller than 35 ml/100 g, preferably smaller than 30 ml/100 g, particularly preferably smaller than 20 ml/100 g.

The weight-average aggregate size of the lamp black of the invention can be smaller than 500 nm, preferably smaller than 450 nm, particularly preferably smaller than 400 nm.

The D_{mode} of the lamp black of the invention can be smaller than 500 nm, preferably smaller than 450 nm, particularly preferably smaller than 400 nm.

The BET surface area of the lamp black of the invention can be from 20 to 400 m²/g, preferably from 30 to 300 m²/g, measured to ASTM D 6556-00.

The compacted bulk density (powder) can be greater than 300 g/l, preferably greater than 400 g/l, measured to DIN EN ISO 787-11.

The volatiles content of the lamp black of the invention, measured to DIN 53552, can be greater than 0.6% by weight, preferably greater than 0.8% by weight, particularly preferably greater than 1.0% by weight.

The pH of the lamp black of the invention, measured to DIN EN ISO 787-9, can be smaller than 7.0, preferably smaller than 6.0, particularly preferably smaller than 5.0.

The number-averaged primary-particle size of the lamp black of the invention, measured to ASTM D 3849-95a, can be from 50 to 400 nm, preferably from 75 to 300 nm, particularly preferably from 100 to 200 nm.

The invention further provides a process for the production of the lamp blacks of the invention, characterized in that lamp blacks are mechanically comminuted in a rotor ball mill.

The duration of the mechanical comminution can be from 0.1 to 120 minutes, preferably from 0.2 to 60 minutes, particularly preferably from 0.5 to 10 minutes. The mechanical comminution can take place in the dry state and, if appropriate, with addition of additives.

The energy input during comminution with a rotor ball mill can be greater than 0.35 kW/l, preferably greater than 0.45 kW/l, particularly preferably greater than 0.55 kW/l, very particularly preferably greater than 0.75 kW/l. The energy input can take place almost exclusively by way of collision and to a lesser extent by way of friction and shear.

The rotor ball mill can be operated at pressures of from 10⁻⁴ mbar to 3 bar. The rotor ball mill can be operated at temperatures of from −20 to +100° C. The rotor ball mill can be cooled, for example by water. The rotor ball mill can be operated under inert gas, air, or other gases. The rotation rate of the rotor can vary from 200 to 1800 rpm. The relative velocity of the grinding balls can be up to 14 m/s. The grinding balls can have been produced from steel, zirconium oxide, and other suitable materials.

The process of the invention can lower the DBP value of the starting carbon black by at least 20 ml/100 g, preferably by at least 30 ml/100 g, particularly preferably by at least 40 ml/100 g.

Additives can be gaseous, liquid, solid, or solutions of substances in liquids. Gaseous additives can be, for example, oxygen, nitrogen, carbon dioxide, hydrogen, ammonia, ozone, or nitrous gases. Liquid additives can be, for example, water, alcohols, hydrocarbons, or oils. Solid additives can be salts, waxes, wetting agents, or surfactants.

The lamp blacks of the invention can be used in carbon black dispersions, coating material systems, printing inks, plastics, or rubbers.

The invention further provides a coating material characterized in that it comprises the lamp black of the invention.

The coating material of the invention can comprise auxiliaries, such as water, organic solvents, binders, resins, aging stabilizers, UV stabilizers, antiozonants, antioxidants, photoinitiators, antifoams, matting agents, drying inhibitors, hardeners, crosslinking agents, processing aids, viscosity regulators, surfactants, acid regulators, fillers, adhesion promoters, flow control agents, initiators, catalysts, biocides, or waxes.

The invention further provides a plastic mixture, characterized in that it comprises at least one plastic and the lamp black of the invention.

The plastic mixture of the invention can comprise auxiliaries, for example aging stabilizers, heat stabilizers, UV stabilizers, antiozonants, antioxidants, hardeners, vulcanizing agents, crosslinking agents, reaction accelerators, reaction retarders, processing aids, antistatic agents, nucleating agents, lubricants, plasticizers, viscosity regulators, antiblocking agents, surfactants, extenders, acid scavengers, metal deactivators, waxes, or blowing agents.

Plastics that can be used are thermoplastic polyolefins (TPO), such as polyethylene (PE, such as LDPE or HDPE), or polypropylene (PP), propylene copolymers, acrylonitrile-butadiene-styrene (ABS), polyvinyl chloride (PVC, such as PPVC, UPVC), polystyrene (PS), polystyrene-acrylonitrile (SAN), Polyamides (PA, such as PA6, PA66, PA11, PA12, or PA46), polycarbonate (PC), polybutylene terephthalate (PBT), polyethylene terephthalate (PET), polyphenylene oxide (PPO), polyphenylene ether (PPE), ethylene-vinyl acetate (EVA), polyurethane (PU), polymethyl methacrylate (PMMA), polyvinyl alcohol (PVA), and mixtures of these.

The invention further provides a rubber mixture, characterized in that it comprises at least one rubber and the lamp black of the invention.

The rubber used can comprise natural rubber and/or synthetic rubbers. Examples of preferred synthetic rubbers are described in W. Hofmann, Kautschuktechnologie [Rubber technology], Genter Verlag, Stuttgart 1980. They comprise, inter alia,
polybutadiene (BR);
polyisoprene (IR);
styrene/butadiene copolymers (SBR), such as emulsion SBR (E-SBR) or solution SBR (L-SBR). The styrene content of the styrene/butadiene copolymers can be from 1 to 60% by weight, preferably from 2 to 50% by weight, particularly preferably from 10 to 40% by weight, very particularly preferably from 15 to 35% by weight;
chloroprene (CR);
isobutylene/isoprene copolymers (IIR);
butadiene/acrylonitrile copolymers having acrylonitrile contents of from 5 to 60% by weight, preferably from 10 to 50% by weight (NBR), particularly preferably from 10 to 40% by weight (NBR), very particularly preferably from 15 to 35% by weight (NBR);
partially hydrogenated or fully hydrogenated NBR rubber (HNBR);
ethylene/propylene/diene copolymers (EPDM);
abovementioned rubbers which also have functional groups, such as carboxy, silanol, or epoxy groups, examples being epoxidized NR, carboxy-functionalized NBR, or SBR functionalized by silanol (—SiOH) moieties or by silylalkoxy (—Si—OR) moieties;
   or else mixtures of said rubbers. In particular, anionically polymerized SSBR rubbers (solution SBR) with a glass transition temperature above −50° C. are of particular interest for car tire threads, as also are mixtures of these with diene rubbers.

The rubber mixtures of the invention can comprise further rubber auxiliaries, such as reaction accelerators, aging stabilizers, heat stabilizers, light stabilizers, antiozonants, processing aids, plasticizers, tackifiers, blowing agents, dyes, pigments, waxes, extenders, organic acids, retarders, metal oxides, and activators, such as triethanolamine or hexanetriol.

The invention further provides a carbon black dispersion, characterized in that it comprises the lamp black of the invention.

The carbon black dispersions of the invention can comprise organic solvents and/or water.

The carbon black dispersions of the invention can comprise biocides, wetting agents, and/or additives, such as antifoams, viscosity regulators, frost stabilizers, and acid regulators.

The lamp blacks of the invention have the advantages of a lowered level of structure and, respectively, average aggregate size, and breadth of aggregate size distribution, and of increased compacted bulk density and volatiles content.

In coating material, the advantages of the carbon blacks of the invention are that tinting strength increases and there is almost no effect on hue. In plastic, the advantage of the carbon blacks of the invention is that tinting strength increases. In rubber, the advantage of the carbon blacks of the invention is that viscosity falls and tensile strength increases.

### EXAMPLES

Methods of Determination

pH:

pH is determined to DIN EN ISO 787-9.

Volatile Content:

Volatile content is determined at 950° C. to DIN 53552.

BET Surface Area:

BET surface area is determined to ASTM D 6556-00.

STSA:

STSA is determined to ASTM D 6556-00.

Tint:

Tinting strength is determined to ASTM D 3265-00.

CTAB Surface Area:

CTAB surface area is determined to ASTM D 3765-99.

Iodine Number:

Iodine number is determined to ASTM D 1510-99.

DBP Adsorption:

DBP adsorption is determined to ASTM D 2414-00.

CDBP Adsorption:

CDBP adsorption is determined to ASTM D 3493-00.

Bulk Density:

Bulk density is determined by a method based on DIN EN ISO 787-11. The pigment black is carefully charged to a 250 ml measuring cylinder with the aid of a funnel. During the charging process, the cylinder is held at angle of 60° until the 250 ml mark has almost been reached. The cylinder is then held vertically and filled exactly as far as the 250 ml mark. Bulk density in g/l is calculated by dividing the weight in g of pigment black by the volume in l of pigment black. The pigment black is not predried and must not be compacted during the charging process.

Compacted Bulk Density:

Compacted bulk density is determined to DIN EN ISO 787-11.

Moisture Content:

Moisture content is determined to DIN EN ISO 787-2.

Primary Particle Size:

Primary particle size is determined to ASTM D 3849-95a.

Aggregate Size Distribution:

A BI-DCP disk centrifuge with red-light diode from Brookhaven is used to measure aggregate size distribution curves. This equipment is specifically developed for determining aggregate size distribution curves of fine-particle solids from extinction measurements, and has an automatic measurement and evaluation program for determining aggregate size distribution.

To carry out the measurements, a dispersion solution is first produced, composed of 200 ml of ethanol, 5 drops of ammonia solution, and 0.5 g of Triton X-100, made up to 1000 ml with demineralized water. A spin fluid is also prepared, composed of 0.5 g of Triton X-100 and 5 drops of ammonia solution, made up to 1000 ml with demineralized water.

20 mg of dispersion solution are then admixed with 20 mg of carbon black, and the carbon black is suspended in the solution in a cooling bath over a period of 4.5 minutes, using ultrasound at 100 watts (80% pulse).

Prior to the beginning of the actual measurements, the centrifuge is operated for 30 minutes at a speed of 11 000 min⁻¹. With the disk spinning, 1 ml of ethanol is injected, and then a bottom layer of 15 ml of spin fluid is carefully laid down. After about a minute, 250 μl of the carbon black suspension are injected, the measuring program of the instrument is started, and the spin fluid in the centrifuge is overlaid with 50 μl of dodecane. A duplicate determination is performed on each test sample.

The raw data curve is then evaluated using the calculation program of the equipment, taking into account the correction for scattered light, and with automatic base line adjustment.

The ΔD₅₀ value (FWHM) is the width of the aggregate size distribution curve at half of the peak height. The D_{mode} value (modal value) is the aggregate size with the greatest frequency (peak maximum of the aggregate size distribution curve).

Black Value My and Absolute Hue Contribution dM:

1. Production of Reagents

Formulation of Diluent

| | | in % by |
|---|---|---|
| Constituents | in g | weight |
| Xylene | 1125 | 68.20 |
| Ethoxypropanol | 225 | 13.63 |
| Butanol | 150 | 9.09 |
| Baysilon OL 17, 10% strength in xylene | 75 | 4.54 |
| Butylglycol | 75 | 4.54 |
| Total | 1650 | 100.00 |

Formulation for Baysilon

| | | in % by |
|---|---|---|
| Constituents | in g | weight |
| Baysilon OL 17 | 10 | 10 |
| Xylene | 90 | 90 |
| Total | 100 | 100 |

Component A

| | | in % by |
|---|---|---|
| Constituents | in g | weight |
| Alkydal F 310, 60% strength | 770 | 77 |
| Diluent | 230 | 23 |
| Total | 1000 | 100 |

Component B

| | | in % by |
|---|---|---|
| Constituents | in g | weight |
| Maprenal MF800, 55% strength | 770 | 77 |
| Diluent | 230 | 23 |
| Total | 1000 | 100 |

The constituents of the 4 formulations are mixed and stored in a suitable vessel.

2. Preparation of Black Coating Material

Formulation for black coating material for determination of black value My:

| | | in % by |
|---|---|---|
| Constituents | in g | weight |
| Standard clear coating material | 27.3 | 65.3 |
| component A | | |
| Standard clear coating material | 12.7 | 30.4 |
| component B | | |
| Pigment black | 1.8 | 4.3 |
| Total | 41.8 | 100 |

Coating material components A and B are first weighed into a PTFE beaker, and then the pigment black, predried at 105° C., is weighed into the beaker, and 275 g of steel shot (Ø=3 mm) are added as grinders. Finally, the specimen is dispersed for 30 minutes in a Skandex mixer.

After the dispersion procedure, about 1-2 ml of black coating material is withdrawn for drawdown, and applied in the form of a strip of length 5 cm and width about 1 cm to the substrate sheet. Care has to be taken that there are no air bubbles in the coating material strip. The film-drawing bar is placed over the coating material strip and drawn uniformly across the sheet. This gives a drawdown of approximately 10 cm in length and 6 cm in width. The coating material drawdown has to be air dried (in a fume cupboard) for at least 10 minutes.

The specimen is then stoved at 130° C. for 30 minutes in a dryer. The specimens can be tested immediately after cooling or subsequently. A Pausch Q-Color 35 tester can be used for the tests, with WinQC+ software. The measurement is made through the glass.

3. Calculations

3.1 Hue-Independent Black Value My and Hue-Dependent Black Value Mc

The hue-independent black value My is first calculated from the measured tristimulus value Y (D65/10 illuminant) (equation 1):

$$My = 100 \cdot log ( \frac{100}{Y} ) \qquad ( 1 )$$

The hue-dependent black value is then calculated (equation) 2):

$$Mc = 100 \cdot ( log ( \frac{{X}_{n}}{X} ) - log ( \frac{{Z}_{n}}{Z} ) + log ( \frac{{Y}_{n}}{Y} ) ) \qquad ( 2 )$$

Xₙ/Zₙ/Yₙ (DIN 6174)=tristimulus values of the coordinate origin, based on the illuminant and the observer (DIN 5033/Part 7, D65/10° illuminant)

Xₙ=94.81 Zₙ=107.34 Yₙ=100.0

X/Y/Z=tristimulus values calculated from the measurements on the specimens.

3.2 Absolute Hue Contribution dM

Absolute hue contribution dM is calculated (equation 3) from the black values Mc and My:

dM=Mc−My (3)

Gray Value Gy and Absolute Hue Contribution dG:

1. Production of Gray Coating Material

Formulation for gray coating material for determining gray value Gy:

| | | in % by |
|---|---|---|
| Constituents | in g | weight |
| White pigment paste (ZP23-0044, BASF) | 31.0 | 62.9 |
| Luwipal 012 hardener (BASF) | 2.3 | 4.7 |
| Black coating material from method | 16.0 | 32.4 |
| described above for “black value My and | | |
| absolute hue contribution dM” | | |
| Total | 49.3 | 100 |

The white paste has to be mixed by stirring with the Skandex, prior to use.

The white pigment paste, the Luwipal 012 hardener, and the black coating material are first weighed into a PTFE beaker, and 60 g of chromanite steel shot (Ø=3 mm) are added as grinders. The specimen is then dispersed for 30 minutes in a Skandex mixer.

After the dispersion procedure, about 1-2 ml of gray coating material is withdrawn for drawdown, and applied in the form of a strip of length 5 cm and width about 1 cm to the substrate sheet. Care has to be taken that there are no air bubbles in the coating material strip. The film-drawing bar (90 μm gap) is placed over the coating material strip and drawn uniformly across the sheet. This gives a drawdown of approximately 10 cm in length and 6 cm in width. The coating material drawdown has to be air dried (in a fume cupboard) for at least 10 minutes.

The specimen is then stoved at 130° C. for 30 minutes in a dryer. The specimens can be tested immediately after cooling or subsequently. A Pausch Q-Color 35 tester can be used for the tests, with WinQC+ software. The measurement is made on the coating material surface.

2. Calculations

2.1 Hue-Independent Gray Value Gy and Hue-Dependent Gray Value Gc

The hue-independent gray value Gy is first calculated from the measured tristimulus value Y (D65/10 illuminant) (equation 1):

$$Gy = 100 \cdot log ( \frac{100}{Y} ) \qquad ( 1 )$$

The hue-dependent gray value is then calculated (equation 2):

$$Gc = 100 \cdot ( log ( \frac{{X}_{n}}{X} ) - log ( \frac{{Z}_{n}}{Z} ) + log ( \frac{{Y}_{n}}{Y} ) ) \qquad ( 2 )$$

Xₙ/Zₙ/Yₙ (DIN 6174)=tristimulus values of the coordinate origin, based on the illuminant and the observer (DIN 5033/Part 7, D65/10° illuminant)

Xₙ=94.81 Zₙ=107.34 Yₙ=100.0

X/Y/Z=tristimulus values calculated from the measurements on the specimens.

2.2 Absolute Hue Contribution dG

Absolute hue contribution dG is calculated (equation 3) from the gray values Gc and Gy:

dG=Gc−Gy (3)

PPVC tinting strength and dispersion hardness:

The PPVC tinting strength and dispersion hardness are determined to DIN EN ISO 13900-2.

### Comparative Example 1 and Inventive Examples 2-4

Table 1 lists the settings for production of the examples of the carbon blacks of the invention and of comparative example 1. A Simoloyer® CM05 rotor ball mill from Zoz GmbH, 57482 Wenden is used.

TABLE 1

| Example | 1 (comparative example) | 2 | 3 | 4 |
|---|---|---|---|---|
| Grinding time min | 0 | 1 | 10 | 60 |

In the inventive examples, 7.5 kg of steel shot with Ø4.8 mm (fill level of grinding medium: 30%) and 600 g of lamp black are charged to the grinding chamber. Once the charging process is complete, nitrogen is used to cover the grinding chamber before closing, for reasons of safety. The milling rotation rate set is 800 rpm. In order to avoid any temperature rise in the mill, the grinding chamber (jacketed) is water-cooled, and the mill is operated alternately for one minute at 800 rpm and one minute at 100 rpm. The grinding time stated is the times for which the mill is operated at maximum rotation rate (800 rpm).

Table 2 shows the analytical data for the carbon blacks of the invention and also for the comparative carbon black. The untreated lamp black is used as comparative example (Example 1).

TABLE 2

| | | Example | | | |
|---|---|---|---|---|---|
| | | 1 | | | |
| | | (comparative | | | |
| | | example) | 2 | 3 | 4 |
| Grinding time | min | 0 | 1 | 10 | 60 |
| Bulk density | g/l | 171 | 234 | 286 | 302 |
| Compacted bulk | g/l | 245 | 357 | 477 | 455 |
| density | | | | | |
| DBP | ml/100 g | 131.2 | 83 | 62.5 | 69.6 |
| CDBP | ml/100 g | 66.5 | 54 | 50.8 | 51 |
| Iodine number | mg/g | 34.2 | 38.7 | 56.1 | 115.9 |
| CTAB | m²/g | 19.4 | 23.2 | 32.8 | 79.5 |
| BET | m²/g | 28.5 | 35.2 | 57.4 | 184.2 |
| STSA | m²/g | 18.5 | 21.1 | 29.5 | 76.3 |
| pH | | 8.4 | 6.7 | 4.5 | 3.6 |
| Volatiles 950° C. | % by wt. | 0.5 | 0.8 | 1.4 | 4.8 |
| Moisture content | % by wt. | 0.3 | 0.4 | 0.4 | 0.6 |
| My | | 218.5 | 216.7 | 218.9 | 233.0 |
| dM | | −0.2 | −0.3 | −1.5 | −4.4 |
| Gy | | 63.2 | 66.4 | 70.5 | 77.2 |
| dG | | 10.1 | 10.4 | 10.8 | 10.1 |
| Tint | % | 26.3 | 29.1 | 33.1 | 29.9 |
| Weight-average | nm | 554 | 465 | 362 | 274 |
| aggregate size | | | | | |
| D_{mode} | nm | 561 | 423 | 341 | 240 |
| FWHM | nm | 588 | 520 | 364 | 267 |
| FWHM/D_{mode} | | 1.05 | 1.23 | 1.07 | 1.11 |
| Spec. surface | m²/g | 7.1 | 8.5 | 10.6 | 14.8 |
| area | | | | | |
| Number-average | nm | 278 | 227 | 202 | 124 |
| aggregate size | | | | | |
| Number-average | nm | 113.2 | 115.8 | 133.5 | 146.6 |
| primary | | | | | |
| particle size | | | | | |

Table 3 states the PPVC tinting strengths and the dispersion hardness values for the carbon blacks of the invention, and also for comparative carbon black 1. The untreated lamp black is used as comparative example 1.

TABLE 3

| Carbon black from example | | 1 (comparative example) | 2 | 3 |
|---|---|---|---|---|
| Tinting strength, 160° C. | % | 37 | 42 | 47 |
| Tinting strength, 130° C. | % | 37 | 40 | 47 |
| Dispersion hardness | | −2 | −3 | −2 |

Table 4 below states the formulation used for the rubber mixtures. The unit phr here means parts by weight based on 100 parts of the crude rubber used. The carbon black used for the mixture of the inventive example is the carbon black of the invention, from inventive example 3. For the reference mixture, the carbon black from comparative example 1 is used.

TABLE 4

| | | |
|---|---|---|
| | | Amount [phr] |
| | Amount [phr] | Mixture of |
| | Reference | inventive |
| Substance | mixture | example |

1st Stage

| | | |
|---|---|---|
| Buna EP G 545524 | 150 | 150 |
| Carbon black | 120 | 120 |
| RS RAL 844 C ZnO | 5 | 5 |
| EDENOR ST1 GS stearic acid | 2 | 2 |
| LIPOXOL 4000 | 5 | 5 |
| SUNPAR 150 | 50 | 50 |
| Stage 1 total | 332 | 332 |

2nd Stage

| | | |
|---|---|---|
| Stage 1 batch | | |
| Vulkacit MERKAPTO C | 1 | 1 |
| Perkacit TBzTD | 1.2 | 1.2 |
| RHENOCURE TP/S | 2 | 2 |
| Sulfur | 1.5 | 1.5 |

The raw materials are available from the following suppliers/producers: Buna from Lanxess AG, LIPOXOL 4000 from Brenntag GmbH, SUNPAR 150 from Sun Oil Company (Belgium) N.V., Vulkacit from Lanxess AG, Perkacit TBzTD (Tetrabenzylthiuram disulfide) from Flexsys N.V., RHENOCURE TP/S from Rheinchemie GmbH, Stearic acid from Caldic B.V. (Germany).

The rubber mixture is produced in two stages in an internal mixer as in Table 5, using economically acceptable mixing times.

TABLE 5
Stage 1

| | |
|---|---|
| Settings | |
| Mixing assembly | Werner & Pfleiderer |
| Friction | 1:1 |
| Rotation rate | 50 min⁻¹ |
| Ram pressure | 5.5 bar |
| Capacity | 1.6 l |
| Fill level | 0.55 |
| Chamber temp. | 80° C. |
| Mixing | |
| procedure | |
| 0 to 3 min | Buna + carbon black + ZnO + |
| | stearic acid + Sunpar 150 |
| 3 to 4 min | Lipoxol 4000 |
| 4 to 5 min | mix and discharge |
| Batch temp. | 120-140° C. |
| Storage | 24 h at room temperature |

Stage 2

| | |
|---|---|
| Settings | |
| Mixing assembly | as in Stage 1 except: |
| Rotation rate | 40 min⁻¹ |
| Fill level | 0.52 |
| Chamber temp. | 80° C. |
| Mixing | |
| procedure | |
| 0 to 2 min | Stage 1 batch + Vulkacit + Perkacit + |
| | RHENOCURE + sulfur |
| 2 min | Discharge and homogenize* on the laboratory |
| | mixing rolls and form milled sheet (diameter |
| | 200 mm, length 450 mm) |
| Batch temp. | 90-105° C. |

*Homogenization: cut the material and fold it over 5 times towards the left and 5 times towards the right, and roll the material 5 times with narrow roll gap (3 mm) and 5 times with wide roll gap (6 mm), and then draw off a milled sheet

The general process for the production of rubber mixtures and their vulcanizates has been described in “Rubber Technology Handbook”, W. Hofmann, Hanser Verlag 1994.

The test methods stated in Table 6 are used for vulcanizate testing.

TABLE 6

| Physical Testing | Standards/Conditions |
|---|---|
| ML 1 + 4, 100° C. (2nd stage) | DIN 53523/3, ISO 667 |
| Vulcameter testing, 165° C. | DIN 53529/3, ISO 6502 |
| Dₘₐₓ − Dₘᵢₙ | |
| t10% | |
| t80% − t20% | |
| Ring tensile test, 23° C. | DIN 53504, ISO 37 |
| (tensile strength, moduli, | |
| elongation at break) | |
| Shore A hardness, 23° C. | DIN 53 505 |
| Ball rebound, 60° C. | DIN EN ISO 8307 steel |
| | shot, 19 mm, 28 g |

Table 7 states the vulcanizate data for crude mixture and vulcanizate.

TABLE 7

| | | | Mixture of |
|---|---|---|---|
| | | Reference | inventive |
| | Unit | mixture | example |
| Data for crude mixture | | | |
| ML (1 + 4) at 100° C. | [MU] | 54 | 36 |
| Dmax − Dmin | [dNm] | 13.2 | 9.4 |
| t 10% (170° C.) | [min] | 0.7 | 1.2 |
| t 90% (170° C.) | [min] | 10.0 | 13.9 |
| Data for vulcanizate | | | |
| Tensile strength | [MPa] | 5.5 | 7.7 |
| 100% modulus | [MPa] | 2.8 | 1.2 |
| 300% modulus | [MPa] | 4.9 | 5.0 |
| 300%/100% modulus | [—] | 1.8 | 4.2 |
| Elongation at break | [%] | 370 | 480 |
| Shore A hardness | [SH] | 58 | 44 |
| Ball rebound, 60° C. | [%] | 63.3 | 69.0 |

The results in Table 7 show that, for the mixing times used here, the mixture of the inventive example, comprising the lamp black of the invention, is superior to the reference mixture. In comparison with the reference mixture, the mixture of the inventive example, comprising the lamp black of the invention, exhibits lower viscosity (ML value), higher tensile strength, and elongation at break, and ball rebound, and also higher 300%/100% modulus value, which is a measure of reinforcement.

The results show that the carbon blacks of the invention (inventive examples 2-4) have a DBP value smaller than 100 ml/100 g. The advantage of the carbon blacks of the invention is apparent in higher tinting strength in the coating material and in the plastic, and in lower viscosity and higher tensile strength in the rubber.

The lamp blacks of the invention have the advantage over furnace blacks, gas blacks, and channel blacks of broader primary-particle- and aggregate-size distribution.

What is claimed is:

1. A lamp black, characterized in that its DBP value is smaller than 100 ml/100 g, measured to ASTM D 2414-00.

2. The lamp black as claimed in claim 1, characterized in that the compacted bulk density is greater than 300 g/l.

3. A process for the production of lamp black as claimed in claim 1, characterized in that lamp blacks are mechanically comminuted in a rotor ball mill.

4. The use of the lamp blacks as claimed in claim 1 in carbon black dispersions, coating material systems, printing inks, plastic mixtures, and rubber mixtures.

5. A coating material, characterized in that it comprises the lamp black as claimed in claim 1.

6. A plastic mixture, characterized in that it comprises at least one plastic and the lamp black as claimed in claim 1.

7. A rubber mixture, characterized in that it comprises at least one rubber and the lamp black as claimed in claim 1.

8. A carbon black dispersion, characterized in that it comprises the lamp black as claimed in claim 1.
